(19) United States
(12) Patent Application Publication
(10) Pub. No.: US 2008/0050188 A1
(43) Pub. Date: Feb. 28, 2008

(54) PORTABLE DRILL HAVING AN INTERNAL COMBUSTION ENGINE

(76) Inventor: Klaus-Martin Uhl, Baltmannsweiler (DE)

Correspondence Address: ROBERT W. BECKER & ASSOCIATES, 707 HIGHWAY 333, SUITE B, TIJERAS, NM, 87059-7507, US

(21) Appl. No.: 11/837,716

(22) Filed: Aug. 13, 2007

Related U.S. Application Data
(63) Continuation-in-part of application No. 10/390,071, filed on Mar. 17, 2003, now abandoned.

(30) Foreign Application Priority Data
Mar. 23, 2002 (DE) 102 13 093.0

(51) Int. Cl. B23B 45/00

(52) U.S. Cl. 408/124; 173/216

(57) ABSTRACT

A portable drill having an internal combustion engine and a shiftable gear mechanism is provided. The gear mechanism has an output shaft for driving a tool. An input shaft of the gear mechanism is driven by a crankshaft of the internal combustion engine. The gear mechanism is provided with a neutral speed or gear setting in which the output shaft is uncoupled from the input shaft.

### CROSS-REFERENCE

The present application is a continuation-in-part application of co-pending Application Ser. No. 10/390,071, which was filed Mar. 17, 2003 and which has a priority date of Mar. 23, 2002 the filing date of its corresponding German patent application number 102 13 093.0.

### BACKGROUND OF THE INVENTION

The present invention relates to a portable drill that has an internal combustion engine and a shiftable gear mechanism that is accommodated in a housing. The gear mechanism has an output shaft for driving a tool, and an input shaft that is driven by the crankshaft of the internal combustion engine.

GB 2 187 664 A discloses a hand-holdable drilling machine having an internal combustion engine that is started by hand by means of a pull cord starter, the crankshaft of which drives an input shaft of a switchable gear mechanism via a centrifugal clutch. The centrifugal clutch connects the crankshaft with the input shaft as soon as the internal combustion engine reaches a speed above the coupling speed. The gear mechanism is a step gear mechanism that brings displaceable gears into successive engagement, so that as a function of the selected gear an output shaft of the gear mechanism and a tool chuck, which is fixedly held to this output shaft, are rotatable at various speeds. Depending on the tool held non-rotatably in the tool chuck, such as a drill, a first or a second speed is adjusted by the operator.

If during full-load operation of such a hand-holdable drilling machine, the drilling tool suddenly becomes stuck. The result is that the internal combustion engine stalls because of the sudden overload and remains stationary. The operation is interrupted. Since the centrifugal clutch ensures the transmission of a high driving torque in operation, the operator must capture this high driving torque when the drilling tool suddenly becomes stuck, which requires substantial forces. This drilling torque corresponds to the maximum power of the internal combustion engine.

After stalling of the internal combustion engine, the internal combustion engine must be restarted. Since the internal combustion engine stalled under full load, a correspondingly fat enriched mixture can be found in the combustion chamber and in the intake system, so that during the starting process the internal combustion engine can ramp up over its idle speed. Thus, the speed also increases to a speed over the coupling speed of the centrifugal clutch, so that the drive connection from the crankshaft of the engine to the output shaft with the blocked tool is closed, which can lead to a sudden load increase on the crankshaft and usually to a further stalling of the just restarted engine.

If the drilling tool is firmly blocked in the drilling hole, the operator therefore must open the drilling chuck and remove the drill from the tool. If then the speed of the internal combustion engine uses above the coupling speed of the centrifugal clutch when the engine is restarted, then the unwanted engagement of the centrifugal clutch does not lead to stalling of the engine, since the output shaft can rotate freely and the newly restarted engine is not slowed down. If the restarted combustion engine again runs at idle speed, the centrifugal clutch is open and the output shaft is stationary. The operator can again place the drilling tool with the drilling chuck of the output shaft onto the shaft of the drill, firmly tighten the drilling chuck, and by giving gas carefully or gradually, the blocked drill again can freely rotate.

A disadvantage of the known hand-held drills therefore is that with a restart of the internal combustion engine its speed usually is higher temporarily than the coupling speed of the centrifugal clutch, so that the clutch engages during the starting process, which is not desired. Then the load torque produced from the fixed drill onto the crankshaft is too high for the running internal combustion engine, which leads to another stalling and downtime of the internal combustion engine. A certain restart of the stalled internal combustion engine therefore is only possible when the drilling tool is removed from the drilling chuck, which is laborious and requires much time for the operator.

### SUMMARY OF THE INVENTION

It is therefore an object of the present invention to improve a portable drill of the aforementioned general type in such a way that it is easier to handle for restarting when a drill is blocked.

To simplify the handling of the portable drill if the drilling tool becomes stuck, and to facilitate a restarting of the internal combustion engine, a switching device is provided in the gear mechanism, which is arranged between an output shaft and an input shaft driven by the crankshaft. If the first position of the switching device is selected, the output shaft, to which the drill chuck is fixedly connected for driving the tool, is separated from the input shaft. In this manner, when restarting the internal combustion engine, the tool chuck does not have to be removed from a blocked drill. A temporary engagement of the speeds dependent switching coupling cannot lead to another stalling of the internal combustion engine, since the output shaft is freely rotatable based on the open drive connection and, thus when the engine starts up no decelerating load can act upon the crankshaft. After starting and restarting of the internal combustion engine, the speed falls below the coupling speed of the speed-dependent switching clutch, so that the drive train is disconnected from the crankshaft to the output shaft by the clutch itself another time. The output shaft is stationary so that the switching device can be brought into its second switching position, in which the drive connection between the input shaft and the output shaft is again closed. The output shaft now connected again with the input shaft will rotate only when the operator of the internal combustion engine accelerates the internal combustion engine and the speed rises above the coupling speed of the speed-dependent switching clutch. Based on the two-time separation of the drive train between the crankshaft and the drilling chuck, the operator can leave the hand-held drill tool of the present invention on the blocked drill also during starting or restarting of the internal combustion engine, which saves much time and expense. The time expense for the work itself is reduced with the portable drill of the present invention.

The switching device is formed advantageously by a gear mechanism for disconnection of the drive train, which has a neutral speed or gear stage. Thus, the switching device advantageously forms a gear shifting mechanism. If the neutral speed or gear stage is engaged by the switching device, the input shaft is disconnected from the output shaft. A load engaging on the tool in the tool chuck cannot act back on the crankshaft. The output shaft is freely rotatably in the neutral gear stage relative to the input shaft or the crankshaft.

For this purposes the gear mechanism has two speed or gear settings in addition to the neutral gear setting, and a gear setting for reversing the direction of the tool. So that after the internal combustion engine has been restarted, various speed or gear settings having different transmission ratios can be selected from the neutral gear setting, it is expedient to design the neutral gear setting in the gear mechanism such that, for example by appropriate arrangement of shifting gears, it is possible to shift directly from the neutral gear setting not only into the first but also into the second speed or gear setting. The switching device can be actuated not only when the internal combustion engine is not running, but also when the engine is in operation.

The actuating element of the switching device is itself preferably mounted in the gear housing. The actuating element is expediently embodied as a rotary knob or handle, with the aid of which the switching device can be actuated or when formed as a gear shifting mechanism, the gear settings can preferably be selected with the following sequence: reversal of direction of rotation—first gear setting—neutral gear setting—second gear setting, and conversely in the opposite direction.

For the manual operation of the rotary knob it is expedient to provide a crossbar or elongated grip element on the rotary knob, one end of which points to the symbols for the switching settings that are disposed about the actuating element on one of the housing parts. The symbols for the individual gear settings are expediently monolithically embodied with the housing component of the portable drill and in particular in the manner of a relief or embossment, i.e. are either stamped into the surface of the housing component or project therefrom. Pursuant to one particularly preferred embodiment of the invention, the actuating element, or the rotary knob, is disposed on a side surface of the portable drill or of the gear housing. With the aid of the inventive neutral gear setting and its disposition between the first and second gear settings it is possible during starting of the internal combustion engine, or after an interruption of the operation of the internal combustion engine due to a drilling tool becoming stuck, to select the neutral gear setting prior to restarting the internal combustion engine, whereby in such neutral gear setting no torque is transmitted to the drilling tool and also no reactive effect of the drilling tool on the internal combustion engine is provided. After starting the internal combustion engine and setting the internal combustion engine to the idling speed, one of the gear settings can be selected and by increasing the speed of the internal combustion engine, as well as by the coupling of the speed-dependent switching clutch that is caused thereby, the drilling tool can be rotated again and can be operated.

### BRIEF DESCRIPTION OF THE DRAWINGS

FIG. 1 is a side view of one exemplary embodiment of an inventive portable drill that has an internal combustion engine;

FIG. 2 is a view of the gear mechanism of the portable drill showing an actuating element of the gear shifting mechanism in the neutral speed or gear stage;

FIG. 3 is a view of the gear mechanism with the actuating 15 element in the position for the first speed or gear setting; and

FIG. 4 is a view of the gear mechanism with the actuating element in the position for the second speed or gear setting.

### DESCRIPTION OF PREFERRED EMBODIMENTS

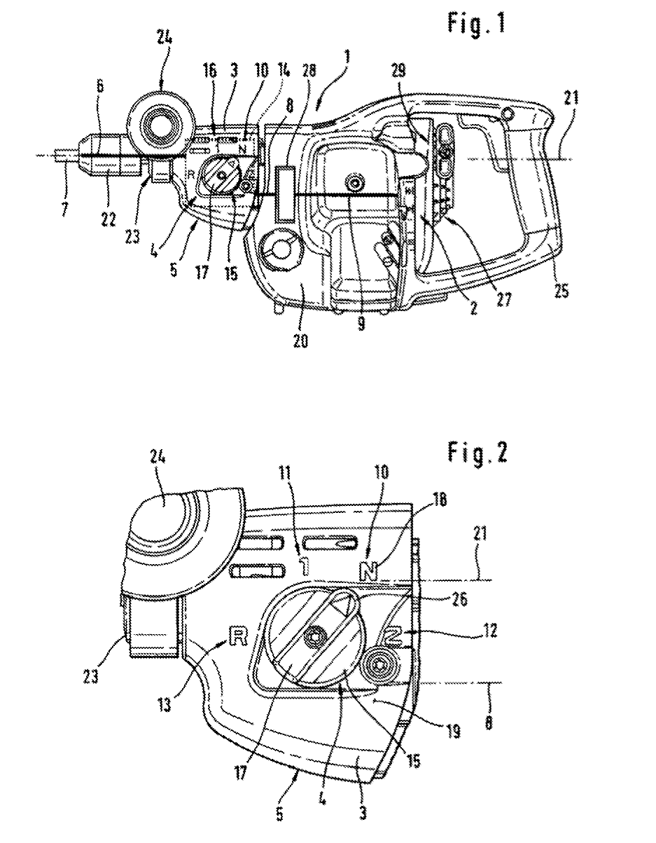

Referring now to the drawings in detail, the side view of FIG. 1 shows a portable drill 1 which essentially comprises a motor housing with an internal combustion engine 2, which has a crankshaft 9, disposed therein as a drive motor. The internal combustion engine 2 can be a valve-controlled or port-controlled two-cycle engine, a four-cycle engine, or some other type of internal combustion engine, such as a rotary piston engine. The internal combustion engine is started via a starting device; in the embodiment shown, a hand-operated pull cord starter 29 is provided. Also other starting devices can be used.

By means of a speed-dependent switching clutch, a so-called centrifugal clutch 28, the schematically shown crankshaft 9 of the internal combustion engine 2 drives a schematically indicated input shaft 8 of a switching device 14, which is formed in the embodiment shown as a gear mechanism 5 that is disposed at one end of the motor housing 20. The gear mechanism 5 forming the switching device 14 is disposed in an encased manner in a gear housing 3. Projecting out of the gear housing 3, in the direction of the longitudinal axis 21 of the portable drill 1, is an output shaft 6, on whose free end a drill or tool chuck 22 is non-rotatably attached. A front handle 24, which can be fixed in any desired position of rotation, is rotatably disposed on a neck 23 of the gear housing 3, preferably by means of an annular flange. Disposed on that end that in the direction of the longitudinal axis 21 of the portable drill 1 is opposite the tool chuck 22 is a handle 25 that spans the end face 27 of the motor housing 20 in a U-shaped manner. The internal combustion engine 2, and the gear mechanism 5 that is fixed in position on the motor housing 20 thereof, form a rigid unit. The gear housing 3 is disposed with adequate play relative to the front end face of the motor housing 20.

The drive train acts on the input shaft 8 from the crankshaft 9 of the internal combustion engine 2 via the centrifugal clutch 28 and further via the switching device 14 formed from the gear mechanism 5 between the input shaft 8 and the output shaft 6 on the output shaft 8 and the tool chuck 22 and can be disconnected twice.

Via the centrifugal clutch 28, the drive train is disconnected a first time: the centrifugal clutch 28 automatically breaks the connection between the crankshaft 9 and the input shaft 8 when below a coupling speed, since a centrifugal clutch can transfer a torque only above a coupling speed. First above the coupling speed, the centrifugal clutch 28 connects the crankshaft 9 in a torque-transferring manner with the input shaft 8. The centrifugal clutch 28 disconnects and connects the crankshaft 9 with the input shaft 8 depending on the actual speed quasi-automatically.

The input shaft 8 is connected with the output shaft 6 via a switching device 14; the drive train is disconnected for a first time with the switching device 14.

In a first switching position 10 (FIG. 2), the switching device 14 separates the output shaft 6 carrying the tool chuck 22 from the input shaft 8. In this first switching position 10 of the switching device 14, a load-free starting of the internal combustion engine 2 is possible since a reactive effect of a decelerating load torque from the output shaft on the crankshaft is avoided.

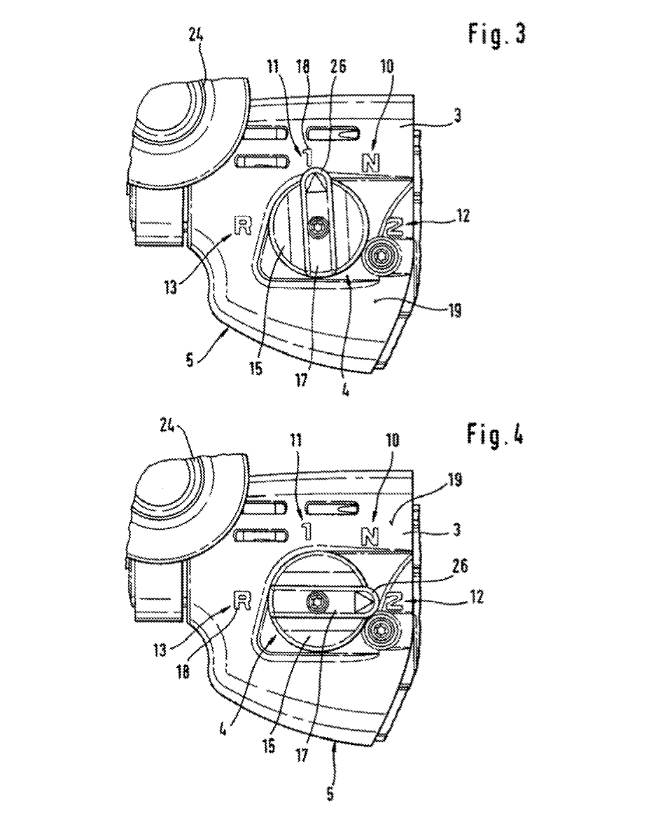

In a second switching position 11 (FIG. 3), the switching device 14 connects the output shaft 6 carrying the tool chuck 22 with the input shaft 8, so that a driving torque can be transferred. In so far as the centrifugal clutch 28 likewise has created the connection between the crankshaft 9 and the input shaft 8.

The switching device 14 can have further switching positions 12 (FIG. 4) or 13, in which likewise a connection between the input shaft 8 and the output shaft 6 is created.

The switching device 14 can be actuated manually via an actuating element 15 when the engine is idling, whereby the actuating element 15 preferably can be locked in its switching positions 10, 11, 12, 13, especially automatically. In this manner, it is ensured that a manually selected switching position is not changed unintentionally based on loads or impact.

As shown in FIGS. 1 to 4, disposed on a side surface 19 of the gear housing 3 is an actuating element that is embodied as a rotary knob or handle 15, and that has a circular base. The rotary knob 15 is part of a gear shifting mechanism 4, which serves for the selection of three speed or gear settings 16 and a neutral speed or gear setting 10 of the gear mechanism 5. For manual actuation thereof, the rotary knob 15 is provided with a grip element 17 that extends from the base thereof and is in the form of a crossbar. The grip element 17 is provided at one of its ends with a projection 26 that extends beyond the base of the rotary knob and via which the grip element is directed in the manner of a pointer toward a respective one of the symbols 18 that indicates a selected gear setting.

In the illustrated embodiment, in FIG. 2 the projection 26 of the grip element 17 is directed toward the symbol “N” on the side surface 19 of the gear housing 3. In this connection, “N” signifies the neutral gear setting 10 in which the output shaft 6 is uncoupled from the input shaft 8, that is the output shaft 6 and the input shaft 8 are separated 20 from one another. The gear mechanism 5 thereby forms the switching device 14 for separating the output shaft 6 from the input shaft 8.

FIGS. 3 and 4 show the positions of the grip element 17 as directed toward the symbols “1”, or “2”, with such operating positions indicating a first gear setting 11 or a second gear setting 12. The first and second speed or gear settings 11 and 12 differ from one another by their respective transmission ratio, and hence different, possible speeds of the output shaft 6 which can be expediently set by gears that can be displaced and fixed in position upon the output shaft 6. In addition, the gear mechanism 5 is provided with a gear setting 13 for reversing the direction of rotation of the output shaft 6, whereby the gear setting 13 on the side surface 19 of the gear housing 3 is characterized by the symbol 18 “R”.

As can be seen from FIGS. 2 to 4, and the arrangement of the symbols 18 (R,1,N,2) on the gear housing 3, the rotary knob 15 is rotatable in a clockwise manner from the gear setting 13 for the reversal of direction via the first gear setting 11, and the neutral gear setting 10 to the second gear setting 12. The gear shifting mechanism 4 is designed such that it can be actuated not only when the internal combustion engine 2 is stopped, but also when it is in operation. The rotary knob 15 can preferably be automatically arrested in every gear setting and is rotatably secured in the gear housing 3 against a reaction force out of such a prescribed position.

As shown in FIGS. 2 to 4, the neutral gear setting 10 is disposed between the first and second gear settings 11 and 12, so that a direct transition to one of these settings is possible. This has the advantage that even if the light conditions are poor, or some other conditions exist that obstruct visibility, the first and second gear settings of the portable drill 1 can be easily and directly set from the neutral gear setting “N” without having to pass through other arresting positions. An operator can quickly become familiar with the arrangement of the gear setting “1” in a counter clockwise direction and the gear setting “2” in a clockwise direction, so that this “blind” locating causes no difficulty. As a consequence of the present invention, a manually actuatable switching device with a neutral gear setting is created, which separates the input shaft 8 from the output shaft 6 for a load-free starting of the internal combustion engine. The reversal of the direction of rotation provided in a further embodiment of the present invention enables operation in both directions of rotation, which can be utilized to release a tool that has become stuck by driving in a first then in another direction.

The specification incorporates by reference the disclosure of German priority document 102 13 093.0 filed Mar. 23, 2002.

The present invention is, of course, in no way restricted to the specific disclosure of the specification and drawings, but also encompasses any modifications within the scope of the appended claims.

I claim;:

1. A portable drill having an internal combustion engine that is started with a starting device, comprising:
a drive train, wherein said drive train rotates an output shaft via a crankshaft and an input shaft, said output shaft provided for driving a tool, wherein the output shaft is non-rotatably connected with a tool chuck for driving the tool, wherein the drive train between the crankshaft and the tool chuck is disconnected twice independently from one another;
a speed-dependent switching clutch disposed between the input shaft and the crankshaft, wherein the speed-dependent switching clutch disconnects the drive train in a first instance, wherein the connection between the crankshaft and the input shaft is broken by the clutch when below a coupling speed, and wherein above the coupling speed, the clutch connects the crankshaft with the input shaft,
a switching device, wherein the output shaft is connected via the switching device with an input shaft, which is driven by a crankshaft of the internal combustion engine, wherein the drive train is disconnected in a second instance with the switching device,
wherein the switching device in a first switching position separates the output shaft carrying the tool chuck from the input shaft,
wherein the switching device in a second switching position connects the output shaft carrying the tool chuck with the input shaft, and
an actuating element, wherein when the internal combustion engine is idling, the switching device is manually actuatable via the actuating element, wherein the actuating element of the switching device is lockable in its switching positions, wherein in the first switching position of the switching device, a load-free restarting of the internal combustion engine is possible without having to remove the tool chuck from a tool that has become stuck.

2. A portable drill according to claim 1, wherein the switching device is formed by a gear mechanism having a neutral gear stage.

3. A portable drill according to claim 1, wherein a gear mechanism is provided having at least a first gear setting and a second gear setting.

4. A portable drill according to claim 2, wherein said gear mechanism is provided with a further gear setting for reversal of a direction of rotation of said output shaft.

5. A portable drill according to claim 2, wherein said neutral gear setting of said gear mechanism is disposed in such a way that it is possible to directly select therefrom either said first gear setting or said second gear setting.

6. A portable drill according to claim 1, wherein the switching device is provided on a housing of a gear and is actuatable during non-running of said internal combustion engine.

7. A portable drill according to claim 1, wherein the switching device is provided on a housing of a gear mechanism and is actuatable in an idling speed range of said internal combustion engine when the latter is in operation.

8. A portable drill according to claim 3, wherein the actuating element of the switching device is provided for a manual selection of one of said gear settings or the neutral gear stage.

9. A portable drill according to claim 1, wherein the actuating element is mounted in a housing of said gear mechanism.

10. A portable drill according to claim 1, wherein said actuating element is a rotary knob.

11. A portable drill according to claim 3, wherein with the actuating element it is possible to successively select the following gear settings of said gear mechanism: reversal of direction of rotation, first gear setting, neutral gear setting, second gear setting, and vice versa.

12. A portable drill according to claim 10, wherein said rotary knob is provided with an elongated grip element that in turn is provided with a projection that points to symbols on said housing that indicate a selected gear setting of said gear mechanism.

13. A portable drill according to claim 10, wherein said rotary knob is provided with a crossbar that is provided with a projection that points to a symbol on said housing that indicates a selected gear setting of said gear mechanism.

14. A portable drill according to claim 1, wherein the actuating element is disposed on a lateral surface of the portable drill or of the housing of a gear mechanism.

15. A portable drill according to claim 1, wherein said output shaft, with said tool chuck, projects out of a housing of a gear mechanism in the direction of a longitudinal axis of said portable drill, and wherein a handle is disposed on an end of said portable drill that as viewed in the direction of said longitudinal axis is opposite said tool chuck.

16. A portable drill according to claim 1, wherein the switching device for separating the power train between the input shaft and the output shaft is formed by a gear shifting mechanism.

17. A portable drill according to claim 10, wherein said rotary knob is adapted to be automatically arrested in each of said gear settings.
